(19) United States
(12) Patent Application Publication
(10) Pub. No.: US 2015/0111634 A1
(43) Pub. Date: Apr. 23, 2015

(54) CASINO WAGERING SYSTEM

(71) Applicant: Chi Fat Au-Yeung, Birmingham (GB)

(72) Inventor: Chi Fat Au-Yeung, Birmingham (GB)

(21) Appl. No.: 14/498,626

(22) Filed: Sep. 26, 2014

(30) Foreign Application Priority Data
Oct. 3, 2013 (GB) GB1317522.9

(51) Int. Cl. G07F 17/32

(52) U.S. Cl. CPC G07F 17/3258; G07F 17/3288
USPC 463/25

(57) ABSTRACT

A method, system, and computer readable storage to implement a wagering system. In one embodiment, when the banker's final hand is a point total of zero using exactly three cards, then players win a payout of 1:2 on the player bet. In another embodiment, if both the player and the banker hand both tie at a total of zero, then the banker bet wins a payout of 1:1.

### CROSS REFERENCE TO RELATED APPLICATIONS

This application claims foreign priority under 35 U.S.C. §119 to application GB1317522.9, filed on Oct. 3, 2013, by inventor Chi Fat Au-Yeung, which is incorporated by reference herein in its entirety.

### BACKGROUND OF THE INVENTION

1. Field of the Invention

The present general inventive concept is directed to a method, apparatus, and computer readable storage medium directed to a wagering game.

2. Description of the Related Art

Casino games (both played in live format and electronic format) are a billion dollar industry. The industry is also striving to produce new and exciting wagering methods which players may find fresh and exciting and the house (casino) finds profitable.

### SUMMARY OF THE INVENTION

It is an aspect of the present invention to provide an exciting casino system.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is flowchart illustrating an exemplary method of implementing a baccarat game with a banker three card zero win, according to an embodiment;

FIG. 2 is a flowchart illustrating an exemplary method of implanting a commission free baccarat game, according to an embodiment;

FIG. 3 is a flowchart illustrating an exemplary method of implementing a baccarat variation, according to an embodiment;

FIG. 4 is a drawing of a gaming table and layout according to an embodiment;

FIG. 5A is a drawing illustrating a gaming table, according to an embodiment;

FIG. 5B is a block diagram illustrating an electronic player tracking system associated with each gaming table, according to an embodiment;

FIG. 6A is a block diagram illustrating exemplary hardware that can be used to implement an electronic version of the methods described herein; and

FIG. 6B is a block diagram illustrating an exemplary network configuration to implement a player playing an online version of the methods described herein;

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

The game of baccarat is described in U.S. Pat. No. 6,299,171 and U.S. publication 2008/0032760, both of which are incorporated by reference herein in their entireties. The game can be played with any number (e.g., 1-8) of standard 52 card decks.

The known game of baccarat is played as follows. The player chooses a bet (a main bet or main wage) to place (player, banker, or tie). The cards are dealt face down, two cards to the player and two cards to the banker, all face up. Depending on the two initial hands, both the player and the banker may draw a third card or stand. The hand with the higher total wins. Note that “dealer” and “banker” are synonymous, thus “dealer's hand” is the same as “banker's hand” and a bet on the “dealer” is the same as a bet on the “banker.”

The cards Ace to Nine are worth 1 to 9 points according to their respective pip-counts. Ten, Jack, Queen and King are each worth zero points. The point total of a hand is the last digit of the sum of the cards. Examples of Baccarat point counts are as follows: Ace(1)+5=6=Hand total=6; 10 (0)+3+6=19=Hand total=9; 9+5=14=Hand total=4.

If the player or the banker (or both) achieve a total of 8 or 9 on the initial deal (known as a ‘natural’), no further cards are drawn and the game is evaluated based on both initial two card hands. If neither player has a natural, then the play proceeds as follows. If the player has an initial total of 0-5, the player draws a third card. If the player then has an initial total of 6 or 7, the player stands.

If the player stands, the banker uses only the banker's own hand and acts according to the same rule as the player (the banker draws a third card if the banker has 0-5 and stands if the banker has 6 or 7).

If the player drew a third card, then the banker acts according to Table I

TABLE I

| Player | |
|---|---|
| Draw Card | Banker Action |
| 2-3 | banker draws if banker has 0-4, stands if banker has 5-7 |
| 4-5 | banker draws if banker has 0-5, stands if banker has 6-7 |
| 6-7 | banker draws if banker has 0-6, stands if banker has 3-7 |
| 8 | banker draws if banker has 0-2 and stands if banker has 3-7 |
| A, 9, 10 or | banker draws if banker has 0-3 and stands if banker has 4-7 |
| face card | |

The player (player or banker) with the highest hand wins. The score of each hand is computed by taking the physical point total of each hand modulo 10, which means that after adding the value of the cards the tens digit is ignored. For example, a hand of 3 and 4 is 7. A hand of 8 and 6 is scored as 4 (14 modulo 10). The first digit is dropped because the total is higher than 9. A hand consisting of 4 and 6 is worth zero. The highest (best) score that can be achieved is 9 (formed using 4/5; face card/9; A/8, 7/2, etc.)

If the banker has the higher hand then the banker bet wins and if the player has the higher hand then the banker bet loses. If the player has the higher hand then the player bet wins and if the banker has the higher hand then the player bet loses. On event of a tie, the player and banker bets will push (neither win nor lose). The player can also bet on a tie. If the player's point total equals the banker's point total then the tie bet wins, otherwise the tie bet loses.

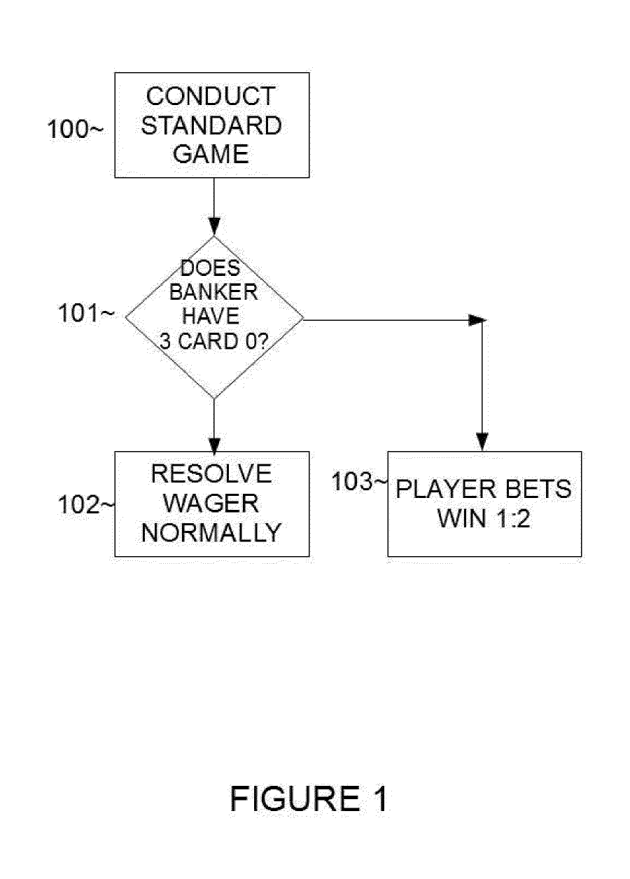

FIG. 1 is flowchart illustrating an exemplary method of implementing a baccarat game with a banker three card zero win, according to an embodiment.

In operation 100, a standard game of baccarat is conducted as described above in operation 100, but without the wager(s) being resolved.

From operation 100, the method proceeds to operation 101 which determines whether the banker has a three card total of zero (0). If not, then the method proceeds to operation 102, which resolves the wager normally (according to the standard baccarat game described herein).

If in operation 101, the banker does have a 3 card total of zero, then the method proceeds to operation 103, in which all bets on the player (as opposed to the banker) win 1:2 (note that other payouts can be used as well). This is regardless of what the player's hand total is. Note that all bets on the banker are still resolved in the standard manner (comparison of the player's hand total to the banker's hand total).

Instead of a three card total of zero (“three card zero”), any other three card point total can be used in place of three card zero, for example three card one, three card two, three card three, etc.

In a further embodiment, when the banker's final hand is a point total of zero using exactly three cards, then all bets on the player will push.

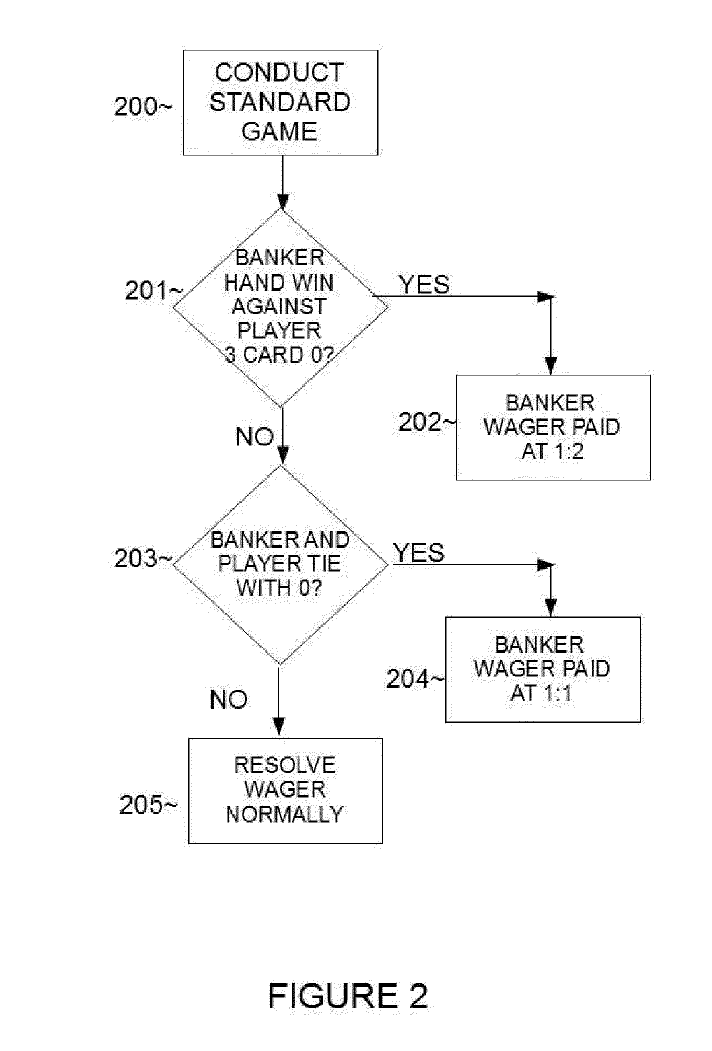

FIG. 2 is a flowchart illustrating an exemplary method of implanting a commission free baccarat game, according to an embodiment.

In operation 200, a standard game of baccarat is conducted as described above in operation 200, but without the wager(s) being resolved.

From operation 200, the method proceeds to operation 201, which determines whether the banker hand wins against a player three card total of zero (0). If the banker's point total is greater than zero and the player hand has a three card point total of zero, then the method proceeds to operation 202 wherein all banker wagers are paid at 1:2 (instead of the standard 1:1 although other payouts can be used as well). Wagers on the player hand lose.

If the result of decision 201 is no, then the method proceeds to operation 203, which determines whether the player's hand and the banker's hand tie with a point total of zero (0). If so, then the method proceeds to operation 204, wherein the banker wagers are paid at 1:1. Wagers on the player hand push.

In a further embodiment, when the player's final hand is a point total of zero using exactly three cards, then all bets on the banker will push.

If the result of decision 203 is no, then the method proceeds to operation 205 which resolves all wagers on the table (or placed virtually) according to the standard game of baccarat (as described herein).

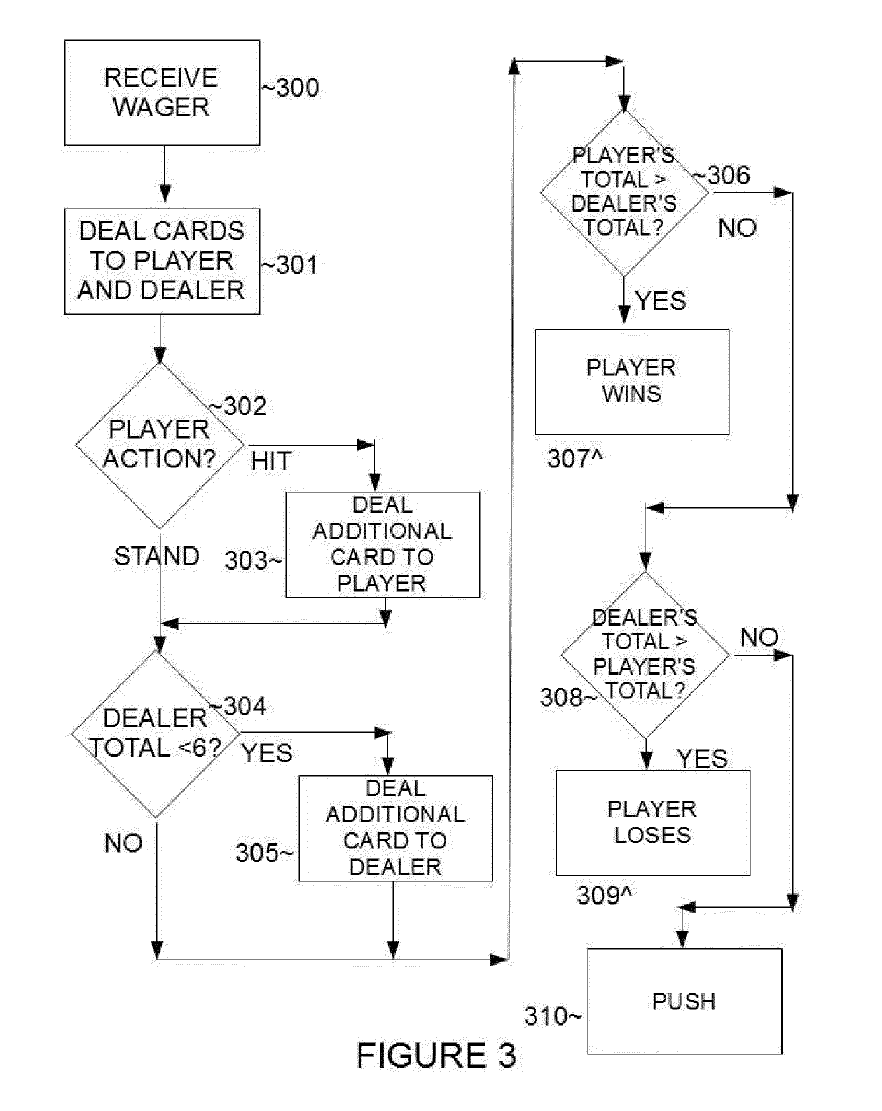

FIG. 3 is a flowchart illustrating an exemplary method of implementing a baccarat variation, according to an embodiment.

The method begins with operation 300, which receives a (main) wager from a player. This can be done as known in the art, by placing a physical chip in a betting circle (the table version) or using a graphical user interface to select a bet amount and click buttons to initiate the wager (electronic version).

The method proceeds to operation 301 which deals two cards to the player (face up) and two cards to the dealer (one face up, one face down).

From operation 301, the method proceeds to operation 302 wherein the player can choose to take only one card (hit) or stand. If the player chooses to hit, then the method proceeds to operation 303, wherein one additional card is dealt to the player and the method proceeds to operation 304.

If in operation 302 the player chooses to stand (not hit) then the method proceeds to operation 304.

In operation 304, it is determined whether the dealer total is lower than 6. If so, then the method proceeds to operation 305, which deals one additional card to the dealer and the method proceeds to operation 306. Other point thresholds besides 6 can be used.

If in operation 304 the dealer total is not lower than 6, then the method proceeds to operation 306.

In operation 306, it is determined whether the player's total is greater than the dealer's total. If so, then the method proceeds to operation 307, wherein the player wins according to a payout table such as that illustrated in Table I. The “pays” column is what is multiplied by the main wager amount from operation 300 to determine the payout.

TABLE I

| Player's Hand | Dealer's Hand | Pays |
|---|---|---|
| 3-3-3 | 0 to 8 | 3 to 1 |
| 2-3-4 | 0 to 8 | 3 to 2 |
| 2 to 9 | 1 to 8 | 1 to 1 |
| 1 to 9 | 0 | 1 to 2 |

Table II below illustrates an alternative paytable.

| Player's Winning Hand | Dealer's Hand | Pays |
|---|---|---|
| Win with: 3-3-3 Suited | Any losing hands | 100 to 1 |
| Win with: 3-3-3 Off-suit | Any losing hands | 15 to 1 |
| Win with: 3-Card 9 point | Any losing hands | 3 to 2 |
| Win with: 3-Card 8 point | Any losing hands | 1 to 1 |
| Win with: 1 to 7 point or 2-Card 8 or 9 | Not a 3-Card Zero | 1 to 1 |
| Win with: 1 to 7 point or 2-Card 8 or 9 | 3-Card Zero | Push |

If in operation 306, the player's total is not greater than the dealer's total, then the method proceeds to operation 308 which determines whether the dealer's total is greater than the player's total. If so, then the player loses the main wager placed in operation 300.

If in operation 308, the dealer's total is not greater than the player's total, then this must mean that the player's total equals the dealer's total and the method proceeds to operation 310 which is a push. The main wager from operation 300 pushes (neither wins nor loses).

In a further embodiment of the method illustrated in FIG. 3, when the dealer's final hand has a point total of zero using exactly three cards, then the main wager placed by the player (in operation 300) will push.

All FIGS. 1-3 relate to baccarat variations which is baccarat scoring. In other words, if the point total (the sum of all the standard values for cards in the hand) is greater than 9, then the first digit of the point total is dropped.

In a further embodiment, a two card side bet can be offered based on the player's or banker's (in baccarat) or dealer's (in blackjack) initial two cards dealt. The player makes a side wager at the same time the player makes the player or banker wager. Two side bet betting circles can be used in each player's betting area, one for a player's cards side bet and one for a banker's cards side bet (baccarat) or a dealer's cards side bet (blackjack). Then the side bet would be applied to the respective set of cards the player bet on. For example, in any baccarat variation, the player can bet on a player's cards side bet which applies the paytable to the player's cards or a banker's side bet which applies the paytable to the banker's cards. The player is free to bet on both side bets if the player wishes. If the initial two cards of the set of cards the player bet the side bet on total either 10 or 20 then the player wins a payout, otherwise the player loses the side bet. Table III below illustrates one possible blackjack paytable, although of course other payouts can be used as well. Blackjack is a known game and is described in U.S. publication 2003/0155715, which is incorporated by reference herein in its entirety. The side wager would be placed when the main wager is placed before any cards are dealt. In the blackjack side bet two betting circles would be present, one which applies the side bet to the player's two initial cards, and one betting circle which applies the side bet to the dealer's two initial cards. The player can choose to bet on none, any one, or both of the betting circles.

TABLE III

| Initial two cards | payout |
|---|---|
| Pair 5's | 25:1 |
| Total 10 (including A-9 but not 5-5) | 10:1 |
| Total 20 (not including A-9) | 2:1 |
| All others | −1 (lose) |

Table IV, below illustrates one possible baccarat paytable, although of course other payout can be used as well. A zero point card is any card that is ten, jack, queen, or king. A non-zero point card is any card that is ace, two, three, four, five, six, seven, eight, nine. Thus, for example, an example of two non-zero point cards that total zero would be a six and a four, which would pay 10:1. An example of two zero point cards that total zero would be a ten and a jack.

TABLE IV

| Initial two cards | payout |
|---|---|
| Pair 5's | 22:1 |
| Two non-zero point cards total zero | 10:1 |
| Two zero point cards total zero | 2:1 |

all others lose

The side wager can be resolved immediately upon the dealing of the card set the player bet the side bet on, or it can be resolved at the end of the game when all wagers are resolved.

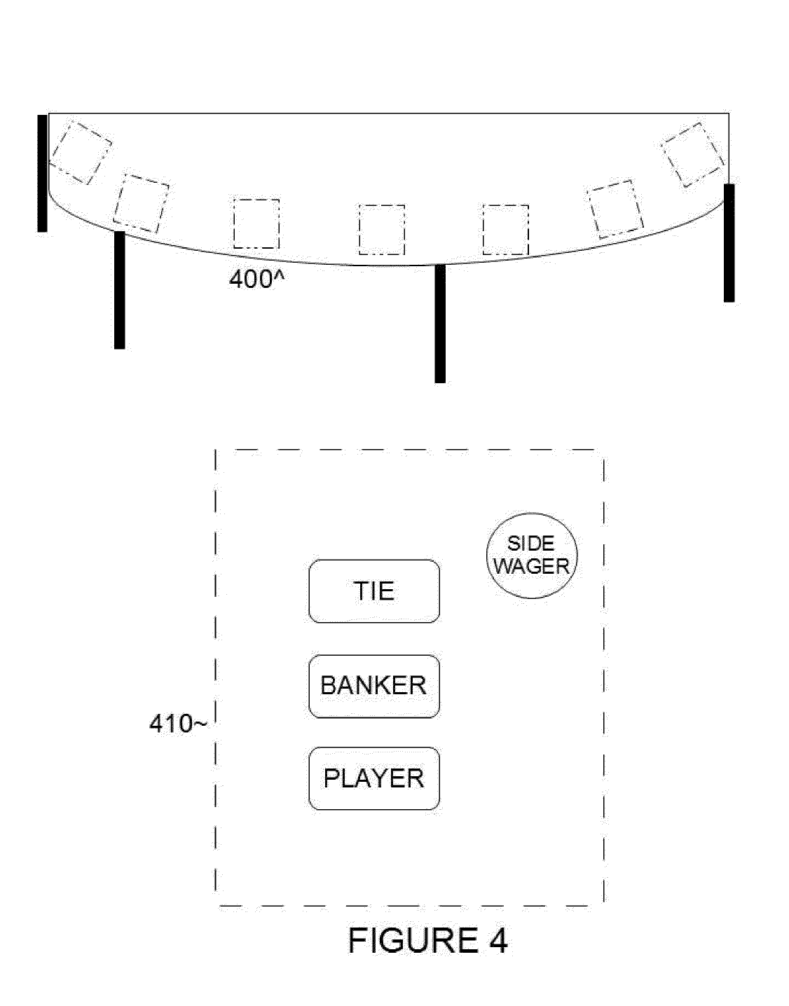

FIG. 4 is a drawing of a gaming table and layout according to an embodiment.

A physical gaming table 400 has seven seats (although of course it can accommodate any other number). This table has seven individual betting areas 10.

Individual betting layout 410 is shown for each player for a baccarat game. Each such layout 410 is in front of each of the players. A banker, player, and tie betting circles are used to place the main wagers (all wagers can be placed in the form of chips). Also present is an optional side wager betting circle.

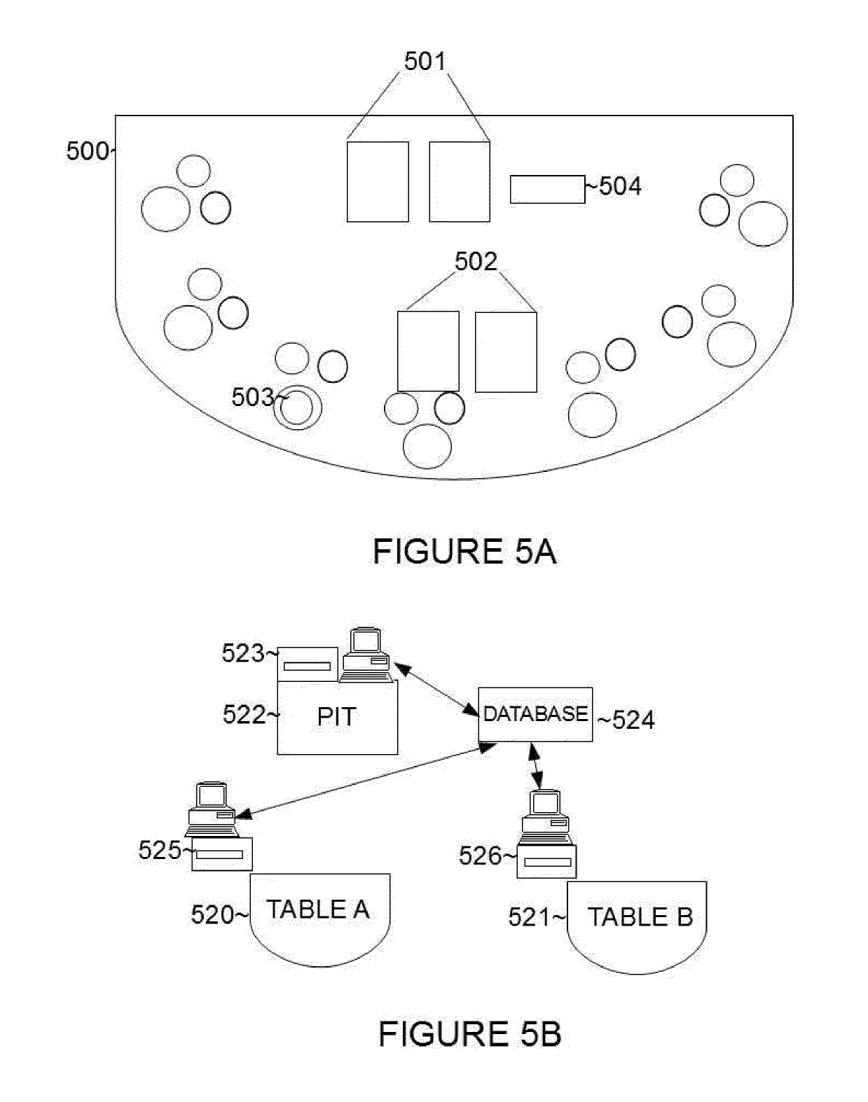

FIG. 5A is a drawing illustrating a gaming table, according to an embodiment.

A physical gaming table 500 (typically made of wood with felt on top with the layout imprinted on it) is used to play the game in a physical real world casino. One example of a table that can be used in a physical casino is illustrated in U.S. Design Pat. D263,975 which is incorporated by reference herein in its entirety. The layout on top of the felt has imprinted on it seven betting circles as illustrated in FIG. 5A, each betting circle is where the respective player can place their chips (wager). The felt can be green and the imprinted betting circles can be white, although of course any color scheme can be used. Such a table can accommodate any number of players (such as seven as illustrated) or any other number (e.g. 2-10). All players play simultaneously against the dealer as known in the art. A player's hand 502 and a dealer's (or banker's) hand 501 are shown. A player's wager 503 is shown in the form of a chip or chips and is placed inside the player's betting circle. The dealer's area can also accommodate a physical card reader 504 for reading the dealer's hole card (for use in a blackjack embodiment) as described in U.S. Pat. No. 5,681,039, which is incorporated by reference in its entirety for all purposes. The physical card reader can be an electronic card reader which electronically scans a face down card and lights up a particular light (e.g., LED, etc.) if the face down card is a 10 or ace (which would give the dealer blackjack when the dealer's up-card is an ace or 10 respectively) otherwise a different light (e.g., a “green light”) lights up telling the dealer that the hole-card does not give the dealer blackjack and thus the dealer can continue dealing.

Each betting circle also has two side wager betting circles (one based on the player's two cards and one based on the dealer's two cards), the player is free to bet on either or both. Similarly, in a baccarat-type game, two such betting circles would also be present, one for the player hand and one for the banker hand. Also not pictured in FIG. 5A is an electronic mechanical shuffler such as that described in U.S. Pat. No. 8,025,294 which is incorporated by reference here in its entirety which can optionally be used by the dealer to shuffle the deck or decks of cards. Also not pictured in FIG. 5A is an optional shoe which the cards can be placed into and dealt out of by the dealer, such as the shoe described in U.S. Pat. No. 4,457,512 which is incorporated by reference herein in its entirety.

FIG. 5B is a block diagram illustrating an electronic player tracking system associated with each gaming table, according to an embodiment.

When players play casino table games the casino can typically track the player so that the casino knows how much gaming action a player is giving the casino and hence how much to reward each player with complimentaries (free or discounted rooms, food, etc.) Such a system is described in U.S. Pat. No. 5,836,817, which is incorporated by reference herein in its entirety for all purposes. Each player can have their own players card which is a plastic card that has their name imprinted on it and computer readable indicia (e.g., a magnetic stripe) which stores an identification number of the player's card (and hence the identification number of the player who owns the card). The player's card can be swiped through an electronic card readers 323, 325, 326 which can be electronic read and the data therein transmitted to the associated computer.

A gaming table A 520 (which can be used to play any method described herein) and a gaming table B 521 (which can be used to play any method described herein) can be associated with a pit 522 (which has its own computer) which has a card reader 523 to read the electronically encoded information on a player's card (the card reader can also be located at the tables themselves) and transmit the information to an associated computer which can communicate information contained on the player's card (e.g., an identification number of the player associated with the card) to the electronic database 524 along with play data relating to the player who owns the player's card. Table A 520 has its own card reader 525 and associated computer (the one next to card reader 525 which receives information from the card reader 525) and table B 521 also has its own card reader 526 and associated computer (the one next to card reader 326 which receives information from the card reader 526). The computers at table A 520 and table B 521 are connected to the electronic database 524. Casino employees can enter data regarding each player's play (for those players that present a players card) into a computer at the table or at the pit which transmits the play data (e.g., average bet/wager amount, time of play, etc.) to the electronic casino database 524 that stores playing history information for players at the casino. The computers illustrated in FIG. 5B can all have the structure as illustrated in FIG. 5A.

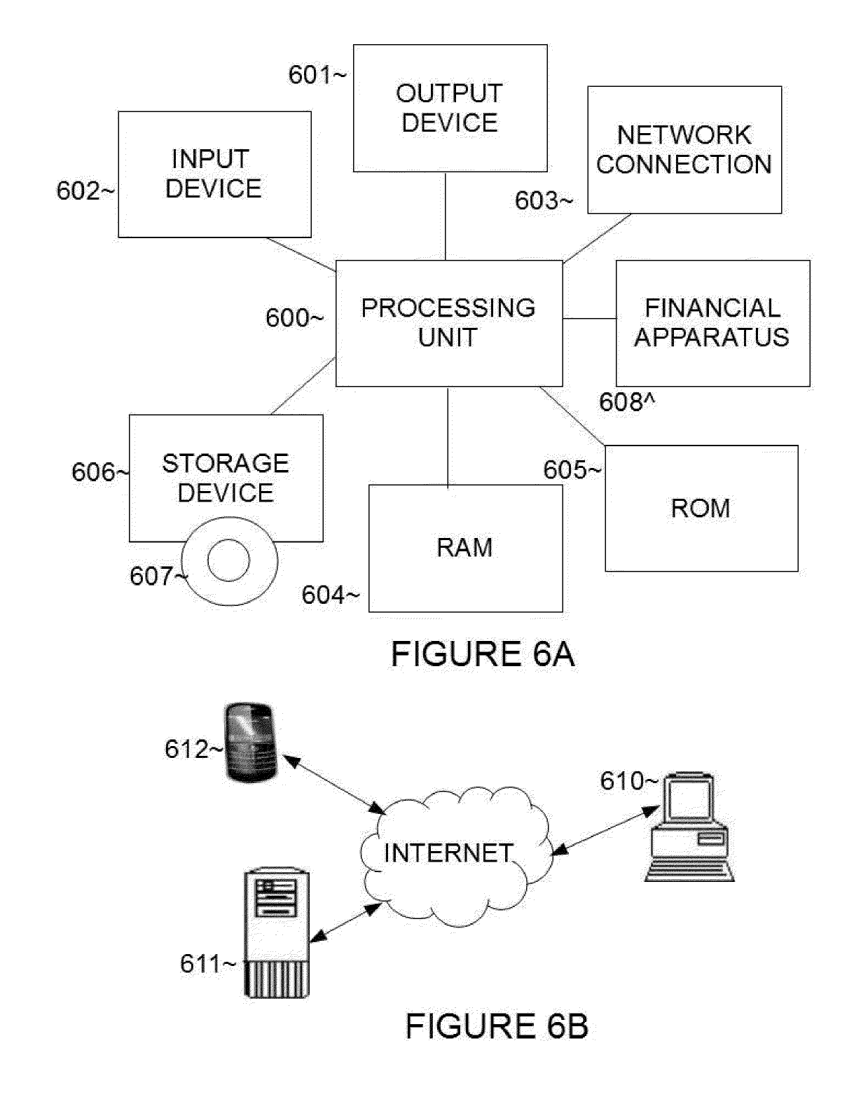

FIG. 6A is a block diagram illustrating hardware that can be used to implement electronic versions of the wagering methods described herein, according to an embodiment. The hardware can be, for example, an electronic gaming machine (EGM) used in casinos. The hardware can also be a personal computer, playing the game using the Internet at an Internet casino for real money. The hardware can also be a digital casino table, for example the kind described in U.S. Pat. No. 7,775,887, which is incorporated by reference herein in its entirety. The hardware can also be any computing device, such as a cellular phone, tablet, etc., and the methods described herein can be installed as software (e.g., an app) on the device. The hardware can also be any other type of device, working individually or in conjunction with other devices. The hardware can also be a digital poker table, of the kind described in U.S. Pat. No. 7,758,411 which is incorporated by reference herein in its entirety.

A processing unit 600 (such as a microprocessor and any associated components) is connected to an output device 601 (such as an LCD monitor, touch screen, CRT, etc.) which is used to display to the player any aspect of the method, and an input device 602 (e.g., buttons, a touch screen, a keyboard, mouse, etc.) which can be used to input from the player any decision made by the player. All methods described herein can be performed by the processing unit 600 by loading and executing respective instructions. The processing unit 600 can also be connected to a network connection 603, which can connect the electronic gaming device to a computer communications network such as the Internet, a LAN, WAN, etc. The processing unit 600 is also connected to a RAM 604 and a ROM 605. The processing unit 600 is also connected to a storage device 606 which can be a DVD-drive, CD-ROM, flash memory, etc. Multiple such processing units can also work in collaboration with each other (in a same or different physical location). A non-transitory computer readable storage medium 607 can store a program which can control the electronic device to perform any of the methods described herein and can be read by the storage device 606. The processing unit 600 can also be connected to a financial apparatus 608 which can receive cash and convert the received cash into playable credits for use by the player when playing the electronic device. When the player decides to cash out any remaining credits, the financial apparatus 608 can issue coins or a cashless ticket (voucher) for the remaining credits which is redeemable by the player.

While one processing unit is shown, it can be appreciated that one or more such processor can work together (either in a same physical location or in different locations) to combine to implement any of the methods described herein. Programs and/or data required to implement any of the methods/features described herein can all be stored on any non-transitory computer readable storage medium (volatile or non-volatile, such as CD-ROM, RAM, ROM, EPROM, microprocessor cache, etc.)

FIG. 6B is a block diagram illustrating an exemplary network configuration to implement a player playing an online version of the methods described herein. All the methods described herein can be implemented on an online casino for real money (credits which are purchased for cash and are redeemable for cash) or for non-cash value credits. A player uses a personal computer 610 (e.g., cell phone, tablet, PC, etc.) can connect to a server 611 (which can have the structure illustrated in FIG. 5A) using a computer communications network such as the Internet. The server 611 hosts an online casino which determines the outcomes of the game and serves the outcomes to the computer 610 so the computer 610 displays the outcomes to the player. Other users can also play at the online casino hosted by the server 611 simultaneously, such as using a cell phone 612 with wireless internet connectivity. Any number of players (e.g., 1 to 100 or more than 100) can be connected to the internet and can play simultaneously on the sever 611 even though these players are all located in different physical locations. The general structure of online casinos is well known in the art.

It is noted that the methods described herein can be played with any number of standard decks of 52 cards (e.g., 1 deck to 10 decks). A standard deck is a collection of cards comprising an Ace, two, three, four, five, six, seven, eight, nine, ten, jack, queen, king, for each of four suits (comprising spades, diamonds, clubs, hearts) totaling 52 cards. Cards can be shuffled or a continuous shuffling machine (CSM) can be used. A standard deck of 52 cards can be used, as well as other kinds of decks, such as Spanish decks, decks with wild cards, etc. The operations described herein can be performed in any sensible order. Furthermore, numerous different variants of house rules can be applied.

Note that in the embodiments played using computers (a processor/processing unit), “virtual deck(s)” of cards are used instead of physical decks. A virtual deck is an electronic data structure used to represent a physical deck of cards which uses electronic representations for each respective card in the deck. A virtual card is displayed on an electronic output device using computer graphics and is displayed to mimic a real life image of that card.

Methods described herein can also be played on a physical table using physical cards and physical chips used to place wagers. Such physical chips can be directly redeemable for cash. When a player wins (dealer loses) the player's wager, the dealer will pay that player a respective payout amount. When a player loses (dealer wins) the player's wager, the dealer will take (collect) that wager from the player and typically place those chips in the dealer's chip rack. All rules, embodiments, features, etc. of a game being played are typically communicated to the player (e.g., verbally or on a written rule card) before the game begins.

Initial cash deposits can be made into the electronic gaming machine which converts cash into electronic credits. Wagers can be placed in the form of electronic credits, which can be cashed out for real coins or a ticket (e.g., ticket-in-ticket-out) which can be redeemed at a casino cashier or kiosk for real cash and/or coins.

Any description of a component or embodiment herein also includes hardware, software, and configurations which already exist in the prior art and may be necessary to the operation of such component(s) or embodiment(s).

Further, the operations described herein can be performed in any sensible order. Any operations not required for proper operation can be optional. Further, all methods described herein can also be stored on a computer readable storage to control a computer. All variations and features described herein can be combined with any other features described herein without limitation. All features in all documents incorporated by reference herein can be combined with any feature(s) described herein, and also with all other features in all other documents incorporated by reference, without limitation.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A method for implementing a wagering game, the method comprising:
executing, on a processing unit, computer readable instructions that perform:
receiving a wager from a player;
dealing two cards to a player and at least one card to a dealer;
enabling the player to receive one additional card at the player's option;
upon a dealer's point total being less than a point threshold, dealing an additional card to the dealer; and
resolving the wager based upon a relationship between the player's point total and the dealer's point total.

2. The method as recited in claim 1, further comprising payout a bonus to the player when the player's hand is a predetermined hand and the dealer's hand is a predetermined hand.

3. The method as recited in claim 1, wherein when the dealer's hand is a three card zero the resolving awards the player a payout of 1:2.

4. The method as recited in claim 1, wherein the player's point total and the dealer's point total are both determined using baccarat scoring.

5. The method as recited in claim 1, wherein the point threshold is 6.

6. An apparatus to implement a wagering game, the apparatus comprising:
an electronic input unit;
an electronic output unit;
a circuit connected to the input unit and the output unit, the circuit comprising a processor, the processor connected to a non-transitory storage device which stores computer readable instructions which cause the processor to:
receive a wager from a player;
deal two cards to a player and at least one card to a dealer;
enable the player to receive one additional card at the player's option;
upon a dealer's point total being less than a point threshold, deal an additional card to the dealer; and
resolve the wager based upon a relationship between the player's point total and the dealer's point total.

7. The apparatus as recited in claim 6, wherein the instructions further cause the processor to award a bonus to the player when the player's hand is a predetermined hand and the dealer's hand is a predetermined hand.

8. The apparatus as recited in claim 6, wherein the instructions further cause the processor to: when the dealer's hand is a three card zero the resolve awards the player a payout of 1:2.

9. The apparatus as recited in claim 6, wherein the instructions further cause the processor to when the dealer's hand is a three card zero the resolve awards pushes the wager.

10. The apparatus as recited in claim 6, wherein the instructions further cause the processor to determine the player's point total and the dealer's point total using baccarat scoring.

11. The apparatus as recited in claim 6, wherein the instructions further cause the processor to set the point threshold to 6.
